(19) United States
(12) Patent Application Publication
(10) Pub. No.: US 2026/0266464 A1
(43) Pub. Date: Sep. 10, 2026

(54) NOZZLE ASSEMBLY, COMBUSTOR, AND GAS TURBINE INCLUDING SAME

(71) Applicant: DOOSAN ENERBILITY CO., LTD., Changwon (KR)

(72) Inventor: Muhwan Chon, Changwon (KR)

(21) Appl. No.: 19/556,164

(22) Filed: Mar. 4, 2026

(30) Foreign Application Priority Data
Mar. 5, 2025 (KR) 10-2025-0027911

(51) Int. Cl. F23R 3/28; F23R 3/34

(52) U.S. Cl. CPC F23R 3/286; F23R 3/343

(57) ABSTRACT

A nozzle assembly, a combustor, and a gas turbine including the same are provided. The nozzle assembly may include a plurality of nozzle modules arranged in a circumferentially spaced relationship and configured to discharge fuel and compressed air into a combustion chamber, wherein each nozzle module includes a fuel supply tube, a fuel manifold coupled to the fuel supply tube, a plurality of fuel injectors disposed at a rear end of the fuel manifold in a radially spaced configuration, each fuel injector being in fluid communication with the fuel manifold and configured to mix fuel with air to discharge a fuel-air mixture, and a pilot injector disposed at a central portion of the fuel injectors and in fluid communication with the fuel manifold, wherein each fuel injector includes an injector body defining a mixing passage, an air inflow port defined through a side surface of the injector body, and a fuel port defined in the injector body and configured to discharge fuel from the fuel manifold into the mixing passage.

### CROSS REFERENCE TO RELATED APPLICATION

This application claims priority to Korean Patent Application No. 10-2025-0027911, filed on Mar. 5, 2025, the disclosure of which is incorporated herein by reference in its entirety.

### BACKGROUND

### Field

Apparatuses and methods consistent with exemplary embodiments relate to a nozzle assembly, a combustor, and a gas turbine including the same, and more particularly, to a nozzle assembly with a plurality of nozzle modules, a combustor, and a gas turbine including the same.

### Description of the Related Art

Turbines are mechanical devices that generate rotational force through impact or reaction by utilizing a flow of a compressible fluid, such as steam or gas. The turbines include steam turbines that use steam and gas turbines that use high-temperature combustion gas.

Gas turbines are power engines that mix and combust compressed air supplied from a compressor with fuel, and use high-temperature gas produced by combustion to rotate the turbine. Gas turbines are used to drive generators, aircraft, ships, and trains.

The gas turbine includes a compressor, a combustor, and a turbine. The compressor draws in external air, compresses the air, and delivers the compressed air to a combustion chamber. The air compressed by the compressor becomes high pressure and high temperature. The combustor mixes the compressed air supplied from the compressor with fuel and burns a mixture to produce combustion gas which is discharged to the turbine. Turbine blades in the turbine are rotated by the combustion gas to generate power. The generated power is used in various fields, including power generation and driving mechanical devices.

Fuel is injected through nozzles installed in each combustor, which can inject gaseous and liquid fuels. Recently, the use of hydrogen fuel or fuel containing hydrogen has been recommended to suppress carbon dioxide emissions.

In gas turbine combustors, flame temperature and combustion pulsation levels vary depending on the degree of fuel and air mixing. When the degree of fuel-air mixing is high, the fuel concentration becomes uniform. When combustion occurs in a lean fuel status, the flame temperature decreases, reducing exhaust gas emissions such as nitrogen oxides (NOx).

### SUMMARY

Aspects of one or more exemplary embodiments provide a nozzle assembly, a combustor, and a gas turbine including the same, the nozzle assembly being capable of improving fuel-air mixing characteristics to minimize nitrogen oxide emissions and enhance flame stabilization.

Additional aspects will be set forth in part in the description which follows and, in part, will become apparent from the description, or may be learned by practice of the exemplary embodiments.

According to an aspect of an exemplary embodiment, there is provided a nozzle assembly including: a plurality of nozzle modules arranged in a circumferentially spaced relationship and configured to discharge fuel and compressed air into a combustion chamber of a gas turbine, wherein each nozzle module may include: a fuel supply tube defining a fuel passage configured to facilitate fuel flow from a front end toward a rear end; a fuel manifold coupled to a first portion of the fuel supply tube, the fuel manifold defining a fuel supply path configured to distribute fuel circumferentially and radially; a plurality of fuel injectors disposed at a rear end of the fuel manifold in a radially spaced configuration, each fuel injector being in fluid communication with the fuel manifold and configured to mix fuel with air to discharge a fuel-air mixture; and a pilot injector disposed at a central portion of the plurality of fuel injectors and in fluid communication with the fuel manifold, wherein each fuel injector may include: an injector body having a first end in fluid communication with the fuel manifold and a second end defining a discharge orifice, the injector body defining a mixing passage; an air inflow port defined through a side surface portion of the injector body and configured to fluidly direct external air into the mixing passage; and a fuel port defined in the injector body and configured to discharge the fuel supplied from the fuel manifold into the mixing passage.

The injector body may include a plurality of guides spaced apart from each other in the circumferential direction and configured to direct air from the air inflow port into the mixing passage, and the air inflow port may include an air inflow slit formed between the plurality of guides.

Each guide may include a vane unit inclined toward a center to circulate the air supplied through the air inflow slit.

Each guide may include a fuel plenum in fluid communication with the fuel manifold, and the fuel plenum may be in fluid communication with the mixing passage via a connection hole.

The connection hole may include a plurality of connection holes, and the connection holes may be arranged in a circumferential direction of the mixing passage.

The nozzle assembly may further include an extension portion disposed at the second end of the injector body, and the extension portion may define a flow area that increases in a downstream direction along the mixing passage.

The fuel supply path may include a plurality of outer circumferential fuel supply paths radially spaced apart from each other, and a radial fuel supply path connecting radially the plurality of outer circumferential fuel supply paths spaced apart from each other and supplying fuel from the fuel supply tube toward the plurality of outer circumferential fuel supply paths.

The pilot injector may include a pilot body having a first end coupled to the fuel manifold and a second end defining a pilot discharge outlet, the pilot body defining an internal pilot mixing passage and a fuel lancer coaxially disposed within the pilot body, an end of the fuel lancer extending through a head end to define an external space, and a second end of the fuel lancer configured to discharge fuel into the pilot mixing passage, wherein the pilot body may include an air inflow hole configured to fluidly direct air into the pilot mixing passage, and the second end of the fuel lancer may include a first fuel injection hole through which fuel may be injected into the pilot mixing passage.

The air inflow hole may include a plurality of air inflow holes defined through the pilot body and arranged in a circumferential direction of the pilot body.

The fuel lancer may further define a plurality of second fuel injection holes through a circumferential surface thereof to inject fuel into the pilot mixing passage, and each of the plurality of second fuel injection holes may be formed diagonally inclined in a direction from an inner portion of the fuel lancer to an outer portion of the fuel lancer, and the plurality of second fuel injection holes may be arranged in the circumferential direction of the fuel lancer.

Each nozzle module may include a plurality of outer nozzle modules arranged in a circumferential direction to form a ring shape and a central nozzle module arranged in an inner central portion of the plurality of outer nozzle modules.

The plurality of fuel injectors of each outer nozzle module may be arranged in a fan shape, and the plurality of fuel injectors may be arranged in a circular arrangement within the central nozzle module.

According to an aspect of another exemplary embodiment, there is provided a combustor including: a nozzle casing configured to receive compressed air from a compressor and to receive fuel from an outside; a liner connected to the nozzle casing and defining a combustion chamber in which a mixture of fuel and compressed air may be combusted; a transition piece connected to the liner to supply combustion gas generated in the combustion chamber to a turbine; and a nozzle assembly disposed in the nozzle casing and including a plurality of nozzle modules to inject fuel and compressed air into the combustion chamber, wherein each nozzle module may include: a fuel supply tube defining a fuel passage configured to facilitate fuel flow from a front end toward a rear end; a fuel manifold coupled to a first portion of the fuel supply tube, the fuel manifold defining a fuel supply path configured to distribute fuel circumferentially and radially; a plurality of fuel injectors disposed at a rear end of the fuel manifold in a radially spaced configuration, each fuel injector being in fluid communication with the fuel manifold and configured to mix fuel with air to discharge a fuel-air mixture; and a pilot injector disposed at a central portion of the plurality of fuel injectors in fluid communication with the fuel manifold, wherein each fuel injector may include: an injector body having a first end in fluid communication with the fuel manifold and a second end defining a discharge orifice, the injector body defining a mixing passage; an air inflow port defined through a side surface portion of the injector body and configured to fluidly direct external air into the mixing passage; and a fuel port defined in the injector body and configured to discharge fuel supplied from the fuel manifold into the mixing passage.

According to an aspect of another exemplary embodiment, there is provided a gas turbine including: a compressor configured to compress air introduced from an outside; a combustor configured to mix fuel with the air compressed by the compressor and combust a mixture of the fuel and air to produce combustion gas; and a turbine including a plurality of turbine blades rotated by combustion gas produced by the combustor, wherein the combustor may include: a nozzle casing configured to receive compressed air from the compressor and to receive fuel from the outside; a liner connected to the nozzle casing and defining a combustion chamber in which a mixture of fuel and compressed air may be combusted; a transition piece connected to the liner to supply combustion gas generated in the combustion chamber to the turbine; and a nozzle assembly disposed in the nozzle casing, and including a plurality of nozzle modules to inject fuel and compressed air into the combustion chamber, wherein each nozzle module may include: a fuel supply tube defining a fuel passage configured to facilitate fuel flow from a front end toward a rear end; a fuel manifold coupled to a first portion of the fuel supply tube, the fuel manifold defining a fuel supply path configured to distribute fuel circumferentially and radially; a plurality of fuel injectors disposed at a rear end of the fuel manifold in a radially spaced apart configuration, each fuel injector being in fluid communication with the fuel manifold and configured to mix fuel with air to discharge a fuel-air mixture; and a pilot injector disposed at a central portion of the plurality of fuel injectors and in fluid communication with the fuel manifold, wherein each fuel injector may include: an injector body having a first end in fluid communication with the fuel manifold and a second end defining a discharge orifice, the injector body defining a mixing passage; an air inflow port defined through a side surface portion of the injector body and configured to fluidly direct external air into the mixing passage; and a fuel port defined in the injector body and configured to discharge fuel from the fuel manifold into the mixing passage.

According to one or more exemplary embodiments, the nozzle assembly, the combustor, and the gas turbine including the same have advantage of improving the mixing characteristics of fuel and compressed air, thereby minimizing nitrogen oxide emissions and improving flame stability.

Furthermore, each fuel manifold is equipped with a plurality of fuel injectors and one fuel supply tube, and the fuel manifold is designed as a module that supports the fuel injectors and the fuel supply tube, making assembly, disassembly, and inspection easy, and each nozzle module has an advantage of simplifying fuel-sealing structure of the flange due to fuel supply through the fuel supply tube.

### BRIEF DESCRIPTION OF THE DRAWINGS

The above and other aspects will become more apparent from the following description of the exemplary embodiments with reference to the accompanying drawings, in which:

FIG. 1 is a perspective view showing an inner portion of a gas turbine according to an exemplary embodiment;

FIG. 2 is a sectional view showing a combustor of FIG. 1;

FIG. 3 is a front view schematically showing a nozzle assembly shown in FIG. 2;

FIG. 4 is an enlarged front view showing an outer nozzle module shown in FIG. 3;

FIG. 5 is a view showing a plurality of fuel injectors shown in FIG. 4, which are connected to a fuel supply tube via a fuel manifold;

FIG. 6 is a cross-sectional view showing a section of a fuel injector at an air inflow port shown in FIG. 5;

FIG. 7 is an enlarged view showing the fuel injector shown in FIG. 5;

FIG. 8 is an enlarged view showing a pilot injector shown in FIG. 5; and

FIG. 9 is an enlarged front view showing a central nozzle module shown in FIG. 3.

### DETAILED DESCRIPTION

Various modifications and various embodiments will be described in detail with reference to the accompanying drawings. However, it should be noted that various embodiments are not for limiting the scope of the disclosure to the specific embodiments, but they should be interpreted to include all of modifications, equivalents, additions or substitutions of the embodiments included within the scope and spirit disclosed herein.

The terminology used herein is for the purpose of describing specific embodiments only and is not intended to limit the scope of the disclosure. As used herein, the singular forms “a”, “an”, and “the” are intended to include the plural forms as well, unless the context clearly indicates otherwise. It will be further understood that the terms “comprise”, “include”, “have” specify the presence of stated features, integers, steps, operations, elements, components, and/or combinations thereof, but do not preclude the presence or addition of one or more other features, integers, steps, operations, elements, components, and/or combinations thereof.

Terms such as “first,” “second,” and so on may be used to describe a variety of elements, but the elements should not be limited by these terms. The terms are used simply to distinguish one element from other elements. The use of such ordinal numbers should not be construed as limiting the meaning of the term. For example, the components associated with such an ordinal number should not be limited in the order of use, placement order, or the like. If necessary, each ordinal number may be used interchangeably.

The terms, such as ‘part’ or ‘module’, etc., should be understood as a unit that performs at least one function or operation and that may be embodied as hardware, software, or a combination thereof. With respect to an element described as a “unit” or “module”, two or more elements may be combined into a single element, or a single element may be divided into two or more elements according to the subdivided functions. Also, each element described below may additionally perform some or all of functions performed by other elements, in addition to its main functions, and some of the main functions of each element may be performed entirely by other components.

Hereinbelow, exemplary embodiments will be described in detail with reference to the accompanying drawings. It is noted that like reference numerals refer to like parts throughout the various drawings and exemplary embodiments. In certain embodiments, detailed descriptions of known functions and configurations which are deemed to make the gist of the present disclosure obscure will be omitted. For the same reason, some components in the accompanying drawings may be exaggerated, omitted, or simplified.

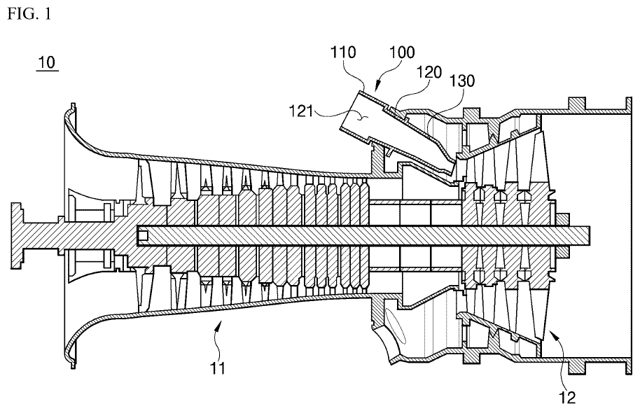

Referring to FIG. 1, a gas turbine 10 includes a compressor 11, a combustor 100, and a turbine 12. Based on a flow direction of gas (e.g., compressed air or combustion air) in the gas turbine 10, the compressor 11 is arranged at an upstream side and the turbine 12 is arranged at a downstream side. combustor 100 is arranged between the compressor 11 and the turbine 12.

The compressor 11 includes a compressor vane and a compressor rotor in a compressor casing, and the turbine 12 includes a turbine vane and a turbine rotor in a turbine casing. The compressor vane and the compressor rotor are arranged in a multistage arrangement in the flow direction of compressed air, and the turbine vane and the turbine rotor are also arranged in a multistage arrangement in the flow direction of combustion gas.

The compressor 11 is designed such that an inner space is gradually decreased in size from a front stage to a rear stage, thereby compressing the drawn air. On the other hand, the turbine 12 is designed such that an inner space is gradually increased in size from the front stage to the rear stage so that the combustion gas received from the combustor 100 can expand.

A torque tube for transmitting a rotational torque generated from the turbine 12 to the compressor 11 is arranged between the compressor rotor that is located at the rearmost stage of the compressor 11 and the turbine rotor that is located at the foremost stage of the turbine 12. FIG. 1 illustrates a case in which the torque tube includes a plurality of torque tube discs arranged in a three-stage arrangement, but it is understood that this is merely one example and other exemplary embodiments are not limited thereto. For example, the torque tube may include a plurality of torque tube discs arranged in an arrangement of equal to or greater than four stages or an arrangement of equal to or less than two stages.

Each of the compressor rotor includes a compressor rotor disc and a compressor blade fastened to the compressor rotor disc. That is, the compressor 11 includes a plurality of compressor rotor discs disposed in the compressor casing, and the compressor rotor discs are coupled to each other by a tie rod to prevent axial separation in an axial direction. The compressor rotor discs are arranged in the axial direction with the tie rod extending through a central portion thereof. Adjacent compressor rotor discs are arranged such that opposing surfaces thereof are in tight contact with each other by being tightly fastened by the tie rod so that the adjacent compressor rotor discs cannot rotate relative to each other.

A plurality of compressor blades is radially coupled to an outer circumferential surface of each of the compressor rotor discs. A plurality of compressor vanes installed in a ring shape on the inner circumferential surface of the compressor casing is alternately arranged with the compressor blades in each stage. While the compressor blades rotate along with a rotation of the tie rod, the compressor vanes are fixed to the compressor casing so as not to rotate. The compressor vanes guide the flow of compressed air moved from front-stage compressor blades to rear-stage compressor blades. Herein, the compressor casing and the compressor vanes may be collectively referred to as a compressor stator to be distinguished from the compressor rotor.

The compressor stator includes a compressor inlet scroll strut, the compressor casing, and the compressor vanes. The compressor inlet scroll strut is connected to a front end of the compressor casing and guides external air into an inlet of the compressor casing. The compressor vanes include an inlet guide vane disposed at a foremost upstream position. The inlet guide vane guides air introduced into the compressor casing to the compressor blades and the compressor vane arranged at a rear end of the compressor casing.

The tie rod is disposed to extend through the central portion of the plurality of compressor rotor discs and the central portion of turbine rotor discs, one end of the tie rod is fastened to an inner portion of the compressor rotor disc located at the foremost stage of the compressor 111, and a an opposite end is fastened in the torque tube by a fixing nut.

It is understood that the tie rod is not limited to the example illustrated in FIG. 1 and may be changed or vary according to one or more other exemplary embodiments. For example, there are three types of tie rods: a single-type in which a single tie rod extends through the central portion of each compressor rotor discs and the central portion of each turbine rotor discs, a multi-type in which multiple tie rods are arranged circumferentially, and a composite type in which the single-type and the multi-type are combined.

Also, the compressor 11 of the gas turbine 10 may include a deswirler, which serves as a guide vane to adjust the flow angle of a fluid entering the combustor inlet to a designed flow angle.

High-temperature and high-pressure combustion air discharged from the combustor 100 is supplied to the turbine 12. The high-temperature and high-pressure combustion gas supplied to the turbine 120 expands while passing through the inner portion of the turbine 120. This expansion applies an impact force and reaction force to a turbine blade, thereby generating rotational torque. The generated rotational torque is transmitted to the compressor through the torque tube. An excessive portion of the rotational torque exceeding the power required to drive the compressor is used to drive a generator or the like.

The turbine 12 is similar in structure to the compressor 11. That is, the turbine 12 includes a plurality of turbine rotors similar to the compressor rotors of the compressor 11. Each turbine rotor includes a turbine disc and a plurality of turbine blades radially disposed around the turbine disc. The turbine disc and the plurality of turbine blades are designed in a structure in which they are arranged in a multi-stage spaced apart from each other along a flow direction of the combustion gas. A plurality of turbine vanes are radially coupled to the inner surface of the turbine casing along the circumferential direction such that each stage of turbine vanes is disposed between adjacent stages of turbine blades to guide the flow direction of combustion gas passing through the turbine blades. Here, the turbine casing and the turbine vanes may be collectively referred to as a turbine stator to distinguish them from the turbine rotor.

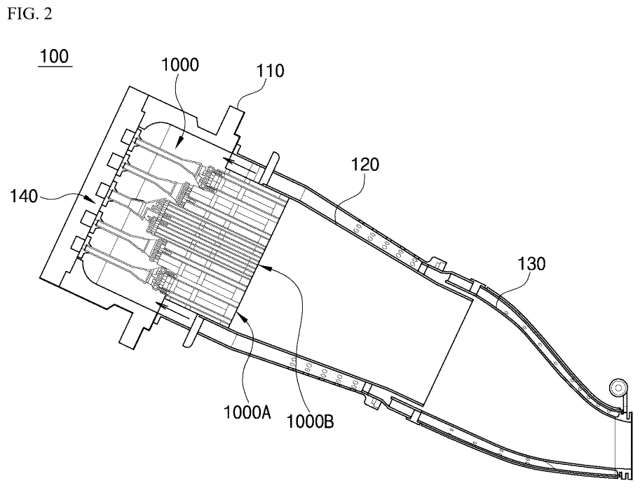

Referring to FIGS. 1 and 2, the combustor 100 includes a nozzle casing 110, a liner 120, a transition piece 130, and a nozzle assembly 140. The nozzle casing 110 has a hollow cylindrical shape and receives fuel from the outside. The nozzle casing 110 is installed in the combustor casing, and the compressed air supplied from the compressor 11 is supplied to the combustor 100 through the combustor casing.

The liner 120 is disposed in the nozzle casing 110 and defines a substantially hollow cylindrical shape. Compressed air flows from the rear space between the liner 120 and the nozzle casing 110 to the front space, and fuel and compressed air are injected inward through the front portion.

In addition, as the mixture of the fuel and the compressed air injected into the liner 120 is burned, high-pressure, high-temperature flames and combustion air are generated. The liner 120 defines a combustion chamber 121 in which combustion occurs. That is, the liner 120 includes the combustion chamber 121 providing a combustion space in which the fuel mixed with the compressed air is combusted.

An end of the liner 120 at the turbine 12 is connected to the transition piece 130, and the transition piece 130 supplies combustion air generated in the combustion chamber 121 into the turbine 120. The transition piece 130 includes a transition piece ring-shaped flow passage formed to surround the internal space thereof, and the compressed air flowing along the transition piece ring-shaped flow passage cools an outer wall portion to prevent damage caused by the high temperature of combustion air.

The nozzle assembly 140 installed in the nozzle casing 110 mixes fuel and compressed air and injects them into the combustion chamber 121.

The nozzle assembly 140 includes a plurality of nozzle modules 1000, and the plurality of nozzle modules 1000 includes outer nozzle modules 1000A and a central nozzle module 1000B.

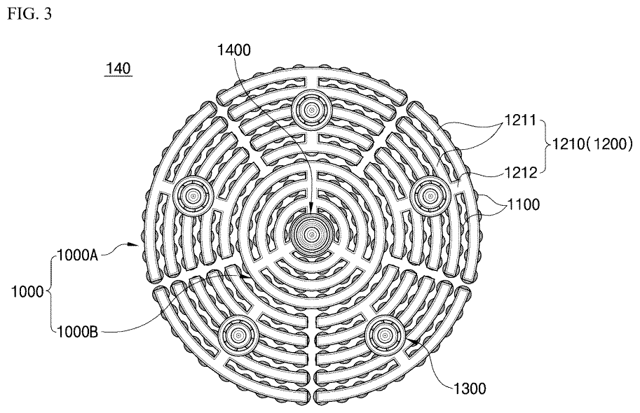

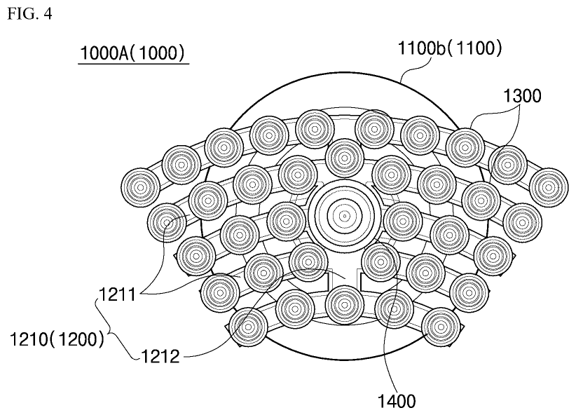

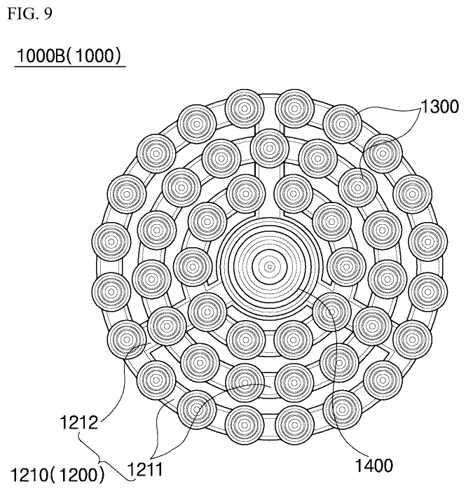

Referring to FIGS. 3 to 5, and 9, the plurality of nozzle modules 1000 includes a fuel supply tube 1100, a fuel manifold 1200, a plurality of fuel injectors 1300, and a pilot injector 1400. A plurality of outer nozzle modules 1000A is arranged circumferentially to define a substantially annular configuration. Within each outer nozzle module 1000A, the plurality of fuel injectors 1300 is arranged in a fan shape. The central nozzle module 1000B is disposed at an inner central portion of the outer nozzle modules 1000A. The plurality of fuel injectors 1300 is preferably arranged in a circular shape in the central nozzle module 1000B.

The fuel supply tube 1100 has a tubular structure to supply fuel. A fuel passage 1100a is defined in the fuel supply tube 1100 to facilitate fuel flow from a front end to a rear end, and a flange 1100b may be disposed at a second portion of the fuel supply tube 1100.

A first portion of the fuel supply tube 1100 is connected to the fuel manifold 1200, and the fuel manifold 1200 defines a fuel supply path 1210 configured to receive fuel from the fuel supply tube 1100 and redistribute said fuel in both a circumferential direction and a radial direction.

The fuel supply path 1210 includes a plurality of outer circumferential fuel supply paths 1211 and a radial fuel supply path 1212. The plurality of outer circumferential fuel supply paths 1211 is arranged to be radially spaced apart from one another. The radial fuel supply path 1212 radially connects the plurality of outer circumferential fuel supply paths 1211 which are spaced from each other and supplies fuel from the fuel supply tube 1100 to the plurality of outer circumferential fuel supply paths 1211.

The plurality of fuel injectors 1300 are arranged radially spaced from each other at a rear end of the fuel manifold 1200 having a front end connected to the fuel supply tube 1100, and the plurality of fuel injectors 1300 receive fuel from the fuel manifold 1200, mix the fuel with air, and subsequently inject the mixture.

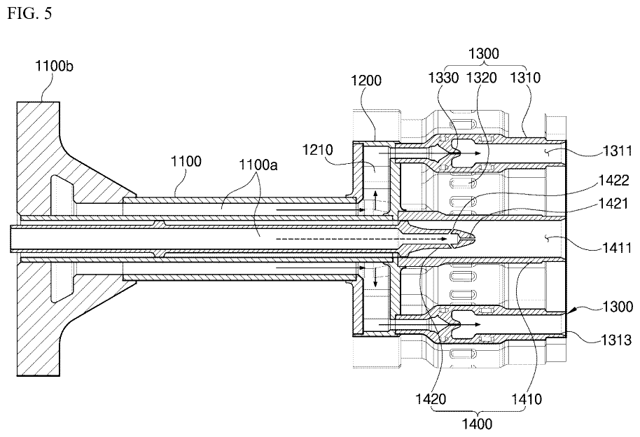

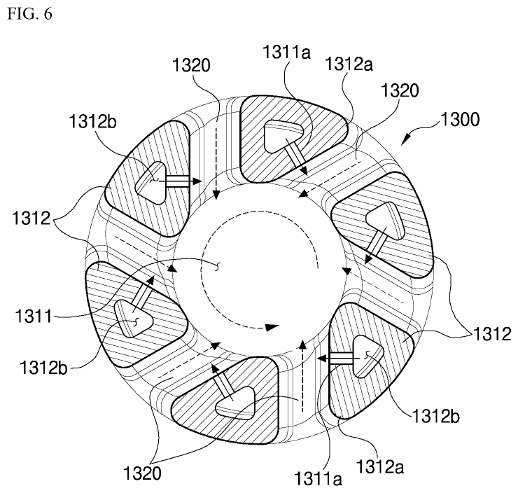

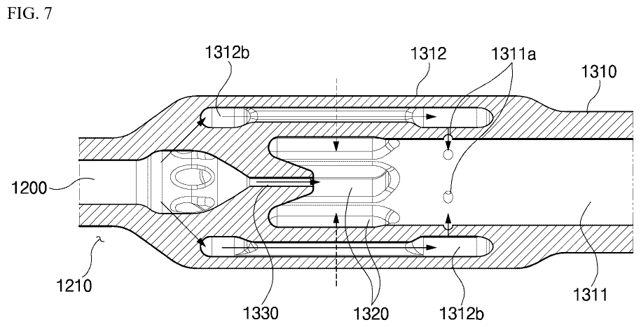

Referring to FIGS. 5 to 7, each fuel injector 1300 includes an injector body 1310, an air inflow port 1320, and a fuel port 1330. A first end of the injector body 1310 is coupled in fluid communication with the fuel manifold 1200, while a second end thereof defines a discharge orifice. The inner portion of the injector body 1310 defines a mixing passage 1311 through which air and fuel flow.

The air inflow port 1320 is defined through a side surface portion of the injector body 1310, and air outside the injector body 1310 is introduced into the mixing passage 1311 through the air inflow port 1320.

The fuel port 1330 is defined in the injector body 1310, and the fuel supplied from the fuel manifold 1200 is discharged to the mixing passage 1311 through the fuel port 1330. It is preferable that one fuel port 1330 is formed in the injector body 1310 to discharge the fuel to a central portion of the mixing passage 1311, but it is not limited thereto, and a plurality of fuel ports 1330 may be formed in the injector body 1310 to discharge the fuel to the entire portion of the mixing passage 1311.

The injector body 1310 includes a plurality of guides 1312 disposed therein so as to be spaced from each other in a circumferential direction of the injector body 1310. The plurality of guides 1312 guide external air of the injector body 1310, which is introduced through the air inflow port 1320, to the mixing passage 1311. In an exemplary embodiment, the air inflow port 1320 is an air inflow slit formed between the plurality of guides 1312 spaced apart from each other in the circumferential direction of the injector body 1310.

The plurality of guides 1312 spaced apart from each other in the circumferential direction of the injector body 1310 include a vane unit 1312a inclined toward the center to rotate air entering through the air inflow port 1320, i.e., the air inflow slit, and the vane unit 1312a includes a plurality of vane units 1312a provided to be spaced apart from each other in the circumferential direction of the injector body 1310.

A fuel plenum 1312b is provided to each of the plurality of guides 1312 arranged to be spaced apart from each other in the circumferential direction of the injector body 1310. The fuel plenum 1312b is connected to the fuel manifold 1200, and the fuel plenum 1312b is connected to the mixing passage 1311 through a connection hole 1311a. Fuel supplied from the fuel manifold 1200 is supplied to the fuel plenum 1312b, and the fuel supplied to the fuel plenum 1312b is supplied to the mixing passage 1311 through the connection hole 1311a.

The connection hole 1311a connected to the mixing passage 1311 includes a plurality of connection holes 1311a, and the plurality of connection holes 1311a are arranged to be spaced apart from each other in a circumferential direction of the mixing passage 1311.

Meanwhile, fuel supplied from the fuel manifold 1200 is supplied along the fuel plenum 1312b installed on a side wall of the injector body 1310 and discharged to the mixing passage 1311 through the plurality of connection holes 1311a formed circumferentially in the injector body 1310. The plurality of connection holes 1311a may be used with the fuel port 1330 or separately from the fuel port 1330, thereby improving fuel-air mixing degree at an outlet end of the mixing passage 1311.

The injector body 1310 may further include an extension portion 1313 disposed at a second end thereof. The extension portion 1313 is formed to increase a flow area in a downstream direction of the mixing passage 1311, and may be formed from a central portion of the injector body 1310 to a second end. When the extension portion 1313 is arranged at the second end of the injector body 1310, the mixture of air and fuel is diffused while passing through the extension portion 1313, thereby improving the mixing degree of air and fuel.

In this case, in the extension portion 1313, a linear cross-section may be partially formed at an end of the second end of the injector body 1310, and a flow cross-section area may be maintained in the cross-section. If the extension portion 1313 includes a linear cross-section, the linearity of the air-fuel mixture fluid can be improved.

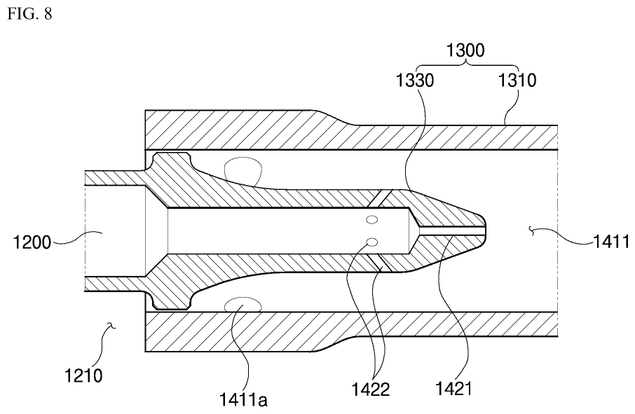

Referring to FIGS. 5 and 8, the pilot injector 1400 is disposed at a central portion of the plurality of fuel injectors 1300, and the pilot injector 1400 receives fuel from the fuel manifold 1200 and injects it.

The pilot injector 1400 includes a pilot body 1410 and a fuel lancer 1420. A first end of the pilot body 1410 is mounted to the fuel manifold 1200, a second end of the pilot body 1410 is open, and a pilot mixing passage 1411 through which air and fuel flow is formed in the pilot body 1410.

The fuel lancer 1420 is connected to the first end of the pilot body 1410, and the fuel lancer 1420 is inserted and connected to the first end of the pilot body 1410. A first end of the fuel lancer 1420 has a structure that can protrude outward of the combustor through the flange 1100b and the head end of the combustor. The fuel lancer 1420 receives fuel through a dedicated fuel tube and injects the supplied fuel into the pilot mixing passage 1411 formed in the pilot body 1410 through the second end thereof.

An air inflow hole 1411a is formed in the pilot body 1410, and external air of the pilot body 1410 is introduced into the pilot mixing passage 1411 through the air inflow hole 1411a.

A plurality of air inflow holes 1411a is defined through the pilot body 1410, and it is preferable that the plurality of air inflow holes 1411a are arranged to be spaced apart from each other in the circumferential direction of the pilot body 1410.

The fuel lancer 1420 has a first fuel injection hole 1421 formed in a central portion of a second end of the fuel lancer 1420 and injects fuel to a central portion of the pilot mixing passage 1411.

A plurality of second fuel injection holes 1422 are formed on a circumferential surface of the fuel lancer 1420, and the plurality of second fuel injection holes 1422 are formed diagonally inclined from an inner portion of the fuel lancer 1420 to an outer portion, and it is preferable that the plurality of second fuel injection holes 1422 are arranged in the circumferential direction of the fuel lancer 1420.

By using the fuel injector 1300 and the pilot injector 1400, the characteristics of the fuel-compressed air mixture can be improved, thereby minimizing nitrogen oxide emissions and improving flame stabilization.

While one or more exemplary embodiments have been described with reference to the accompanying drawings, it will be apparent to those skilled in the art that various modifications and variations can be made through additions, substitutions, changes, or deletions of components without departing from the scope and spirit of the disclosure as disclosed in the accompanying claims, and these modifications and changes fall within the scope and spirit of the disclosure as defined in the appended claims.

What is claimed is:

1. A nozzle assembly comprising:
a plurality of nozzle modules arranged in a circumferentially spaced relationship and configured to discharge fuel and compressed air into a combustion chamber of a gas turbine,
wherein each nozzle module comprises:
a fuel supply tube defining a fuel passage configured to facilitate fuel flow from a front end toward a rear end;
a fuel manifold coupled to a first portion of the fuel supply tube, the fuel manifold defining a fuel supply path configured to distribute fuel circumferentially and radially;
a plurality of fuel injectors disposed at a rear end of the fuel manifold in a radially spaced configuration, each fuel injector being in fluid communication with the fuel manifold and configured to mix fuel with air to discharge a fuel-air mixture; and
a pilot injector disposed at a central portion of the plurality of fuel injectors and in fluid communication with the fuel manifold,
wherein each fuel injector comprises:
an injector body having a first end in fluid communication with the fuel manifold and a second end defining a discharge orifice, the injector body defining a mixing passage;
an air inflow port defined through a side surface portion of the injector body and configured to fluidly direct external air into the mixing passage; and
a fuel port defined in the injector body and configured to discharge the fuel from the fuel manifold into the mixing passage.

2. The nozzle assembly of claim 1, wherein the injector body comprises a plurality of guides spaced apart from each other in the circumferential direction and configured to direct air from the air inflow port into the mixing passage, and
wherein the air inflow port comprises an air inflow slit formed between the plurality of guides.

3. The nozzle assembly of claim 2, wherein each guide comprises a vane unit inclined toward a center to circulate the air supplied through the air inflow slit.

4. The nozzle assembly of claim 3, wherein each guide comprises a fuel plenum in fluid communication with the fuel manifold, and
wherein the fuel plenum is in fluid communication with the mixing passage via a connection hole.

5. The nozzle assembly of claim 4, wherein the connection hole comprises a plurality of connection holes, and
wherein the connection holes are arranged in a circumferential direction of the mixing passage.

6. The nozzle assembly of claim 1, further comprising:
an extension portion disposed at the second end of the injector body,
wherein the extension portion defines a flow area that increases in a downstream direction along the mixing passage.

7. The nozzle assembly of claim 1, wherein the fuel supply path comprises:
a plurality of outer circumferential fuel supply paths radially spaced apart from each other; and
a radial fuel supply path connecting radially the plurality of outer circumferential fuel supply paths spaced apart from each other and supplying fuel from the fuel supply tube toward the plurality of outer circumferential fuel supply paths.

8. The nozzle assembly of claim 1, wherein the pilot injector comprises:
a pilot body having a first end coupled to the fuel manifold and a second end defining a pilot discharge outlet, the pilot body defining an internal pilot mixing passage; and
a fuel lancer coaxially disposed within the pilot body, an end of the fuel lancer extending through a head end to define an external space, and a second end of the fuel lancer configured to discharge fuel into the pilot mixing passage,
wherein the pilot body comprises an air inflow hole configured to fluidly direct air into the pilot mixing passage, and
wherein the second end of the fuel lancer comprises a first fuel injection hole through which fuel is injected into the pilot mixing passage.

9. The nozzle assembly of claim 8, wherein the air inflow hole comprises a plurality of air inflow holes defined through the pilot body and arranged in a circumferential direction of the pilot body.

10. The nozzle assembly of claim 8, wherein the fuel lancer further defines a plurality of second fuel injection holes through a circumferential surface thereof to inject fuel into the pilot mixing passage,
wherein each of the plurality of second fuel injection holes is formed diagonally inclined in a direction from an inner portion of the fuel lancer to an outer portion of the fuel lancer, and
wherein the plurality of second fuel injection holes is arranged in the circumferential direction of the fuel lancer.

11. The nozzle assembly of claim 1, wherein each nozzle module comprises:
a plurality of outer nozzle modules arranged in a circumferential direction to form a ring shape; and
a central nozzle module arranged in an inner central portion of the plurality of outer nozzle modules.

12. The nozzle assembly of claim 11, wherein the plurality of fuel injectors of each outer nozzle module is arranged in a fan shape, and
wherein the plurality of fuel injectors are arranged in a circular arrangement within the central nozzle module.

13. A combustor comprising:
a nozzle casing configured to receive compressed air from a compressor and to receive fuel from an outside;
a liner connected to the nozzle casing and defining a combustion chamber in which a mixture of fuel and compressed air is combusted;
a transition piece connected to the liner to supply combustion gas generated in the combustion chamber to a turbine; and
a nozzle assembly disposed in the nozzle casing and comprising a plurality of nozzle modules to inject fuel and compressed air into the combustion chamber,
wherein each nozzle module comprises:
a fuel supply tube defining a fuel passage configured to facilitate fuel flow from a front end toward a rear end;
a fuel manifold coupled to a first portion of the fuel supply tube, the fuel manifold defining a fuel supply path configured to distribute fuel circumferentially and radially;
a plurality of fuel injectors disposed at a rear end of the fuel manifold in a radially spaced configuration, each fuel injector being in fluid communication with the fuel manifold and configured to mix fuel with air to discharge a fuel-air mixture; and
a pilot injector disposed at a central portion of the plurality of fuel injectors and in fluid communication with the fuel manifold,
wherein each fuel injector comprises:
an injector body having a first end in fluid communication with the fuel manifold and a second end defining a discharge orifice, the injector body defining a mixing passage;
an air inflow port defined through a side surface portion of the injector body and configured to fluidly direct external air into the mixing passage; and
a fuel port defined in the injector body and configured to discharge fuel from the fuel manifold into the mixing passage.

14. The combustor of claim 13, wherein the injector body comprises a plurality of guides spaced apart from each other in the circumferential direction and configured to direct air from the air inflow port into the mixing passage,
wherein the air inflow port comprises an air inflow slit formed between the plurality of guides, and
wherein each of the plurality of guides comprises a vane unit inclined toward a center to circulate the air introduced through the air inflow slit.

15. The combustor of claim 14, wherein each guide comprises a fuel plenum in fluid communication with the fuel manifold,
wherein the fuel plenum is in fluid communication with the mixing passage via a connection hole,
wherein the connection hole comprises a plurality of connection holes, and
wherein the connection holes are arranged in a circumferential direction of the mixing passage.

16. The combustor of claim 13, further comprising:
an extension portion disposed at the second end of the injector body, and
wherein the extension portion defines a flow area that increases in a downstream direction along the mixing passage,
wherein the fuel supply path comprises:
a plurality of outer circumferential fuel supply paths radially spaced apart from each other; and
a radial fuel supply path connecting radially the plurality of outer circumferential fuel supply paths spaced apart from each other and supplying fuel from the fuel supply tube toward the plurality of outer circumferential fuel supply paths.

17. The combustor of claim 13, wherein the pilot injector comprises:
a pilot body having a first end coupled to the fuel manifold and a second end defining a pilot discharge outlet, the pilot body defining an internal pilot mixing passage; and
a fuel lancer coaxially disposed within the pilot body, an end of the fuel lancer extending through a head end to define an external space, and a second end of the fuel lancer configured to discharge fuel into the pilot mixing passage,
wherein the pilot body comprises an air inflow hole configured to fluidly direct air into the pilot mixing passage, and
wherein the second end of the fuel lancer comprises a first fuel injection hole through which fuel is injected into the pilot mixing passage.

18. The combustor of claim 17, wherein the air inflow hole comprises a plurality of air inflow holes defined through the pilot body and arranged in a circumferential direction of the pilot body,
wherein the fuel lancer further defines a plurality of second fuel injection holes through a circumferential surface thereof to inject fuel into the pilot mixing passage,
wherein each of the plurality of second fuel injection holes is formed diagonally inclined in a direction from an inner portion of the fuel lancer to an outer portion of the fuel lancer, and
wherein the plurality of second fuel injection holes is arranged in the circumferential direction of the fuel lancer.

19. The combustor of claim 13, wherein each nozzle module comprises:
a plurality of outer nozzle modules arranged in a circumferential direction to form a ring shape; and
a central nozzle module arranged in an inner central portion of the plurality of outer nozzle modules,
wherein the plurality of fuel injectors of each outer nozzle module is arranged in a fan shape, and
wherein the plurality of fuel injectors of the central nozzle module are arranged in a circular arrangement within the central nozzle module.

20. A gas turbine comprising:
a compressor configured to compress air introduced from an outside;
a combustor configured to mix fuel with the air compressed by the compressor and combust a mixture of the fuel and air to produce combustion gas; and
a turbine comprising a plurality of turbine blades rotated by combustion gas produced by the combustor,
wherein the combustor comprises:
a nozzle casing configured to receive compressed air from the compressor and to receive fuel from the outside;
a liner connected to the nozzle casing and defining a combustion chamber in which a mixture of fuel and compressed air is combusted;
a transition piece connected to the liner to supply combustion gas generated in the combustion chamber to the turbine; and
a nozzle assembly disposed in the nozzle casing and comprising a plurality of nozzle modules to inject fuel and compressed air into the combustion chamber,
wherein each nozzle module comprises:
a fuel supply tube defining a fuel passage configured to facilitate fuel flow from a front end toward a rear end;
a fuel manifold coupled to a first portion of the fuel supply tube, the fuel manifold defining a fuel supply path configured to distribute fuel circumferentially and radially;
a plurality of fuel injectors disposed at a rear end of the fuel manifold in a radially spaced apart configuration, each fuel injector being in fluid communication with the fuel manifold and configured to mix fuel with air to discharge a fuel-air mixture; and
a pilot injector disposed at a central portion of the plurality of fuel injectors and in fluid communication with the fuel manifold,
wherein each fuel injector comprises:
an injector body having a first end in fluid communication with the fuel manifold and a second end defining a discharge orifice, the injector body defining a mixing passage;
an air inflow port defined through a side surface portion of the injector body and configured to fluidly direct external air into the mixing passage; and
a fuel port defined in the injector body and configured to discharge fuel from the fuel manifold into the mixing passage.
